(19) United States
(12) Patent Application Publication
(10) Pub. No.: US 2021/0195094 A1
(43) Pub. Date: Jun. 24, 2021

(54) INFORMATION PROCESSING SYSTEM, INFORMATION PROCESSING APPARATUS, AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/840,613

(22) Filed: Apr. 6, 2020

(30) Foreign Application Priority Data
Dec. 20, 2019 (JP) 2019-230894

(51) Int. Cl. H04N 5/232; G08B 13/196

(52) U.S. Cl. CPC H04N 5/23218; G08B 13/19695; G08B 13/19669; H04N 5/23222

(57) ABSTRACT

An information processing system includes a processor configured to acquire schedule information on schedule of a reservable place in which a photographing apparatus is mounted and set a photographed region to be photographed by the photographing apparatus on a basis of the acquired schedule information.

### CROSS-REFERENCE TO RELATED APPLICATIONS

This application is based on and claims priority under 35 USC 119 from Japanese Patent Application No. 2019-230894 filed Dec. 20, 2019.

### BACKGROUND

### (i) Technical Field

The present disclosure relates to an information processing system, an information processing apparatus, and a non-transitory computer readable medium.

### (ii) Related Art

Japanese Unexamined Patent Application Publication No. 2016-201611 discloses displaying a photographing region icon, which is movable, within an image of a space and allowing a person who is in charge of mounting surveillance cameras to decide where to mount a surveillance camera within the space by moving the displayed photographing region icon.

Japanese Unexamined Patent Application Publication No. 2003-125386 discloses a sensor that detects a movable object within a predetermined range, a lens for photographing that has an angle of view wider than the predetermined range and encompassing the predetermined range, and a shutter that performs a photographing operation based on a detection signal supplied from the sensor.

### SUMMARY

When a person mounts a photographing apparatus in a place, the place can be photographed.

In the place where the photographing apparatus is mounted, an event can occur at various positions. It is not enough to simply mount the photographing apparatus. In a case where the person simply mounts the photographing apparatus, it may be impossible to photograph a target event or it may be impossible to know details of an event from a taken image.

Aspects of non-limiting embodiments of the present disclosure relate to more accurately photographing an event that occurs in a place where a photographing apparatus is mounted as compared with a case where a photographing apparatus is simply mounted to photograph a place where the photographing apparatus is mounted.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to acquire schedule information on schedule of a reservable place in which a photographing apparatus is mounted and set a photographed region to be photographed by the photographing apparatus on a basis of the acquired schedule information.

### BRIEF DESCRIPTION OF THE DRAWINGS

An exemplary embodiment of the present disclosure will be described in detail based on the following figures, wherein:

FIG. 1 schematically illustrates an overall configuration of an information processing system;

FIG. 2 is a view for explaining an example of a booth-type space;

FIG. 3 is a view for explaining an inside of a space;

FIG. 4 is a view for explaining an example of a hardware configuration of a space management server;

FIG. 5 illustrates an example of a hardware configuration of a user terminal;

FIG. 6 illustrates an example of a display screen displayed on a user terminal of a user who requests to reserve a space;

FIG. 7 illustrates another example of a display screen displayed on a user terminal;

FIG. 8 illustrates a reservation list stored in a hard disk drive of the space management server;

FIG. 9 illustrates a user list stored in the hard disk drive of the space management server; and

FIG. 10 is a flowchart illustrating an example of flow of processing executed by a CPU, which is an example of a processor, provided in the space management server.

### DETAILED DESCRIPTION

An exemplary embodiment of the present disclosure is described below with reference to the drawings.

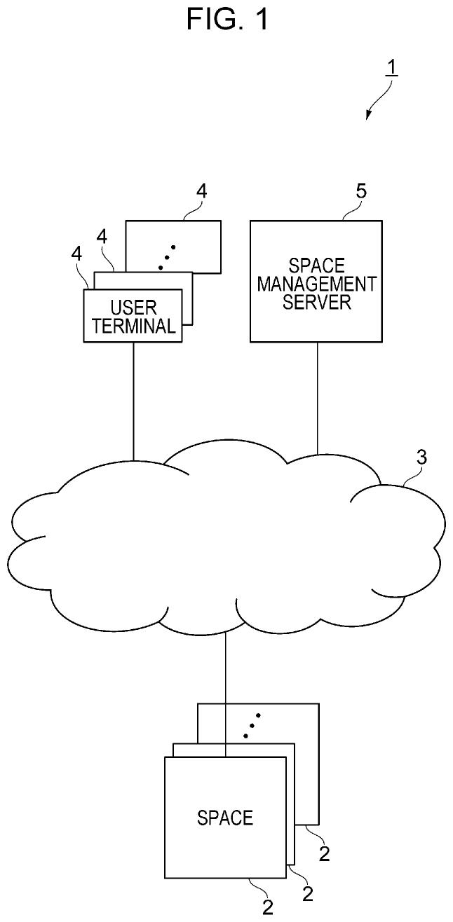

FIG. 1 schematically illustrates an overall configuration of an information processing system 1 according to the present exemplary embodiment.

In the present exemplary embodiment, plural spaces 2, which are an example of places reserved and used by a user, are provided.

In the present exemplary embodiment, each of the spaces 2 is reservable, and a user makes a reservation of a space 2 to use the space 2.

Examples of the spaces 2 include booths, guest rooms of a facility such as an accommodation facility, and conference rooms of a company. These are examples of the spaces 2 that are partitioned from surroundings by a wall, a partition, or the like.

Furthermore, examples of the spaces 2 according to the present exemplary embodiment include tables and seats on which service is offered at a restaurant, a barber shop, or the like. These are examples of the spaces 2 opened to surroundings.

The information processing system 1 illustrated in FIG. 1 includes various terminals connected to a cloud network 3.

In FIG. 1, user terminals 4 operated by users and a space management server 5 that manages the spaces 2 are illustrated as examples of the terminals connected to the cloud network 3. Furthermore, the spaces 2 are connected to the cloud network 3. More specifically, various apparatuses are provided in the spaces 2, and these apparatuses are connected to the cloud network 3.

The spaces 2 may be managed by a single business operator or plural business operators. For example, different business operators may be in charge of management of reservations, management of entry into and exit from rooms, statuses of usage of rooms, and the like, management of charging of usage fees on users, and management of members registered as users.

As described above, the spaces 2 managed as targets reserved by users need not be spaces of the same type. For example, some of the spaces 2 may be booths, and some of the spaces 2 may be seats or tables of a restaurant or the like.

Furthermore, management of a single purpose or function may be provided by plural business operators in cooperation.

In the present exemplary embodiment, doors of the spaces 2 are equipped with an electronic lock so that the spaces 2 can be locked. In the present exemplary embodiment, persons who have an authority to unlock the spaces 2 can access the spaces 2.

To unlock a space 2, a person who tries to unlock the space 2 gives an unlocking instruction by operating his or her user terminal 4. This instruction is sent to the space management server 5, and the space management server 5 receives the instruction. Then, the space management server 5 gives an instruction to unlock the space 2 for which the unlocking instruction is aimed. This causes the electronic lock of the space 2 to operate, thereby unlocking the space 2.

In the present exemplary embodiment, it is assumed that the user terminals 4 are smartphones, which are portable. Note, however, that the portable user terminals 4 may be wearable terminals, notebook computers, or gaming terminals.

The space management server 5 manages various kinds of information related to the spaces 2. For example, the space management server 5 manages information for specifying users, information for specifying the spaces 2 reserved by users, start dates and times of reservations, and end dates and times of reservations.

Examples of the information for specifying users include users' names, genders, ages, accounts, user IDs, passwords, and information for management given to the individuals. Examples of the information for specifying the spaces 2 used by users include information for specifying places such as addresses or locations and names and numbers for management.

The space management server 5 may manage reservations of articles and services associated with the spaces 2. For example, the space management server 5 may manage articles and services that are permitted to be borrowed or used and consumed or consumable articles and services.

Furthermore, the space management server 5 manages various kinds of information related to usage of the spaces 2. For example, the space management server 5 manages information on statuses of usage of the spaces 2 and information on users of the spaces 2.

Furthermore, the space management server 5 unlocks and locks the spaces 2.

The space management server 5 also functions as a control apparatus and controls the various apparatuses provided in the spaces 2. Note that a control apparatus may be provided in each of the spaces 2, and various apparatuses provided in each of the spaces 2 may be controlled by the control apparatus provided in the space 2.

### Appearance Configuration of Spaces 2

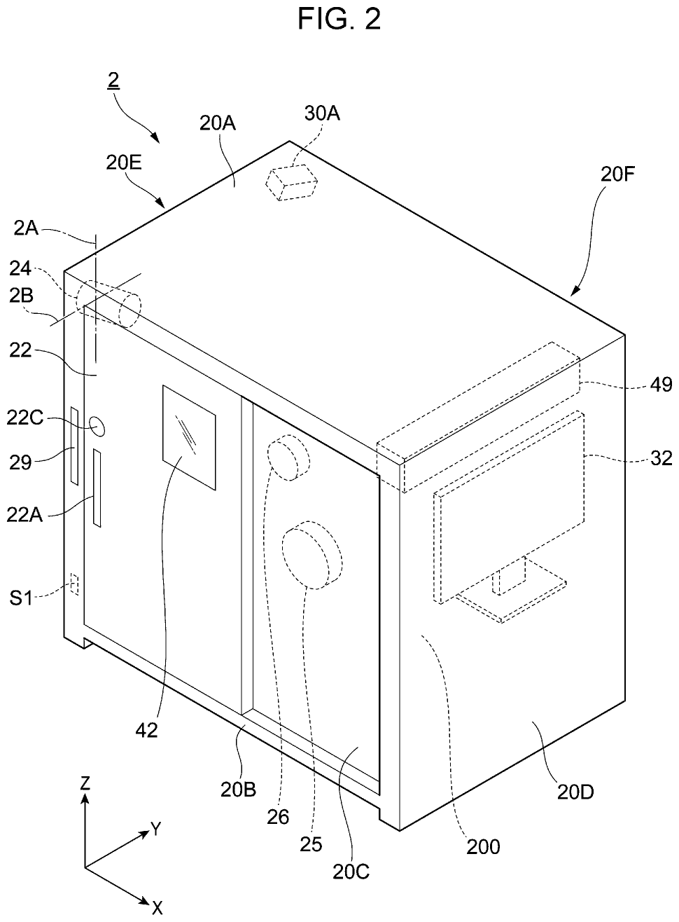

FIG. 2 is a view for explaining an example of a booth-type space 2.

The booth-type space 2 illustrated in FIG. 2 is placed at an indoor or outdoor place such as a train station, an airport, an office building, a commercial facility such as a restaurant or a department store, a bank, a library, an art museum, a museum, a public institution or facility, an accessway, or a park.

The booth-type space 2 illustrated in FIG. 2 is a closed-type booth provided with a ceiling. Note that the closed type does not mean “completely closed” and just needs to have practical sound insulation.

A body of the space 2 illustrated in FIG. 2 includes a ceiling 20A, a floor 20B, a wall 20C equipped with a door 22, which is openable and closable, two walls 20D and 20E located on both sides of the wall 20C, and a wall 20F that faces the door 22.

In the present exemplary embodiment, the space 2 is surrounded by the wall 20C, the door 22, the wall 20D, the wall 20E, and the wall 20F, and a room 200 is created inside these four walls and the door 22 by these four walls and the door 22.

In the present exemplary embodiment, it is assumed that the door 22 is a sliding door that is movable along the wall 20C. Although the door 22 is a single sliding door that slides in one direction in FIG. 2, the door 22 may be a sliding doorset including two or more members sliding on respective lanes or a sliding doorset including two members sliding on a single lane.

In the present exemplary embodiment, the door 22 is provided with a handle 22A used by a user to open or close the door 22. Furthermore, the door 22 is provided with an electronic lock 22C that can lock and unlock the door 22. Furthermore, in the present exemplary embodiment, the door 22 is provided with an opening closing sensor S1 that detects opening and closing of the door 22.

The number of persons which the space 2 accommodates is roughly determined by a volume of the space 2. In the present exemplary embodiment, it is assumed that the space 2 is a cabin-type space that is basically used by a single person.

Note, however, that the space 2 may be a large room that accommodates a large number of persons. The large room may be a single independent room or may be a room created by connecting plural rooms 2 by removing one of or both of the walls 20D and 20E of the spaces 2.

Note that the cabin type does not mean that only one person can use the space and means that a small number of persons (e.g., two or three persons) can use the space.

A shape and a structure of the body, equipment, and performance of the space 2 are not limited in particular. For example, the ceiling 20A may be removed.

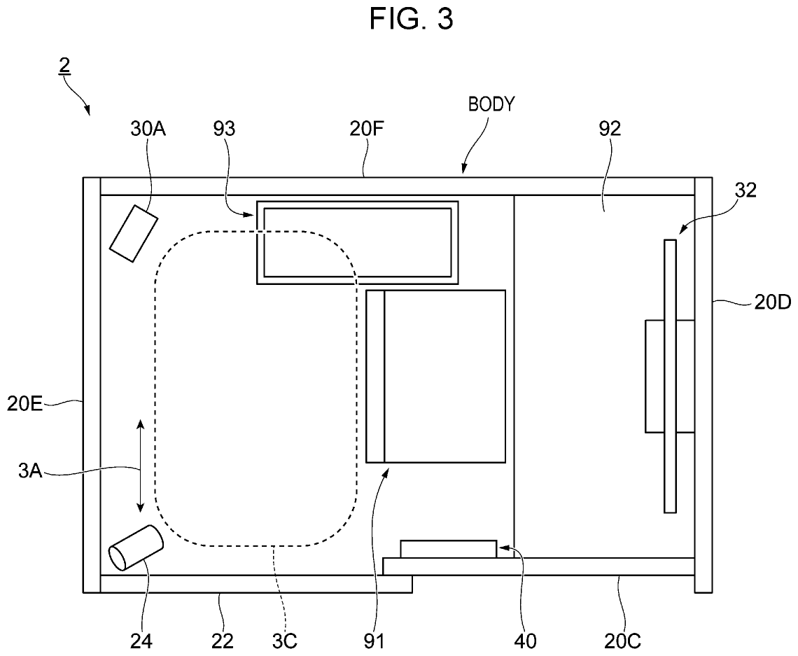

FIG. 3 is a view for explaining an inside of the space 2. FIG. 3 illustrates the space 2 viewed from above.

In the present exemplary embodiment, a single desk 92 and a single chair 91 are placed in the body. Furthermore, prepared equipment and apparatuses and reserved equipment and apparatuses are placed in the body.

Furthermore, a box 93 for storing user's baggage is placed in the space 2. In particular, the space 2 is equipped with the box 93 for storing user's baggage placed by the user.

Furthermore, a monitor 32, which is a display device for displaying an image, is provided as standard equipment in the body.

The monitor 32 is placed on the desk 92. A user can connect his or her personal computer to the monitor 32. In particular, the monitor 32 is used to enlarge an image displayed on a screen of the user's PC.

In the present exemplary embodiment, an image displayed on a screen of a PC is displayed on the monitor 32 by connecting the PC to the monitor 32 by using a cable (not illustrated).

As illustrated in FIGS. 2 and 3, in the present exemplary embodiment, a speaker 30A, which is a sound output device for outputting sound, is provided. Alternatively, sound may be output from a speaker of the monitor 32.

As illustrated in FIGS. 2 and 3, in the present exemplary embodiment, a photographing apparatus 24 that photographs an inside of the space 2 is provided. The photographing apparatus 24 has an imaging element such as a Charge Coupled Device or a CMOS and photographs an inside of the space 2 by using this imaging element.

Furthermore, a moving mechanism that moves the photographing apparatus 24 in a direction indicated by arrow 3A in FIG. 3 is provided in the space 2. In particular, in the present exemplary embodiment, a moving mechanism that moves the photographing apparatus 24 in a direction along the wall 20E is provided.

This moving mechanism includes, for example, an annular belt that can circulate and extends along the wall 20E, a mount that is attached to this belt and supports the photographing apparatus 24, and a driving motor that drives the belt.

The moving mechanism is not limited to this configuration and can be any known mechanism.

Furthermore, in the present exemplary embodiment, a first rotating mechanism that rotates the photographing apparatus 24 is provided. The first rotating mechanism is supported by the mount and rotates the photographing apparatus 24 about a rotary axis indicated by reference sign 2A in FIG. 2. In particular, the first rotating mechanism rotates the photographing apparatus 24 about a rotary axis extending in a vertical direction.

Furthermore, in the present exemplary embodiment, a second rotating mechanism that rotates the photographing apparatus 24 is provided. The second rotating mechanism is also supported by the mount and rotates the photographing apparatus 24 about a rotary axis indicated by reference sign 2B. In particular, the second rotating mechanism rotates the photographing apparatus 24 about a rotary axis extending in a horizontal direction.

The first rotating mechanism and the second rotating mechanism may be any known mechanisms and are not limited in particular.

As illustrated in FIG. 2, a human sensor 25 that detects a user in the space 2 is provided in the space 2. Furthermore, a temperature sensor 26 that detects a temperature in the space 2 is provided.

As illustrated in FIG. 3, a lighting apparatus 40 (a light source) for illuminating an inside of the space 2 is provided in the space 2. Furthermore, in the present exemplary embodiment, an air-conditioning apparatus 49 that adjusts a temperature in the space 2 is provided as illustrated in FIG. 2.

Furthermore, in the present exemplary embodiment, the door 22 has a window 42 as illustrated in FIG. 2. In the present exemplary embodiment, a person can see an inside of the space 2 from an outside of the space 2 through the window 42.

Furthermore, as illustrated in FIG. 2, an information acquisition device 29 for acquiring individual information of a user of the space 2 may be provided on an outer face of the body.

The information acquisition device 29 is, for example, a reader that reads an ID card held by a user. Alternatively, the information acquisition device 29 may be a reader that reads a fingerprint, a pattern of veins, and the like of a user.

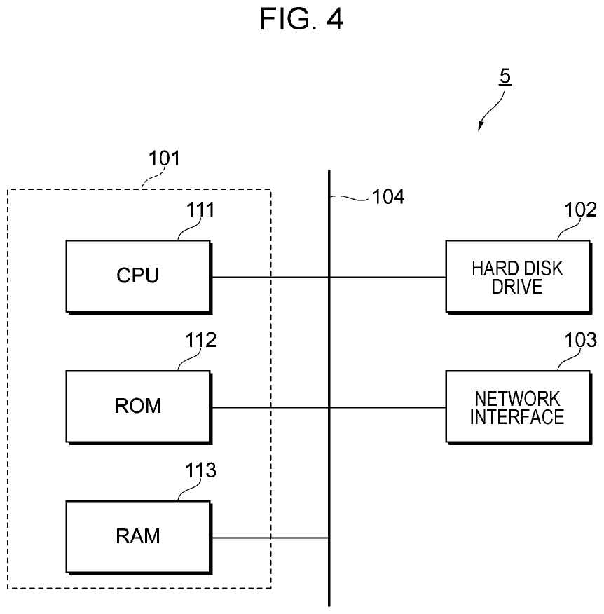

FIG. 4 is a view for explaining an example of a hardware configuration of the space management server 5.

The space management server 5, which is an example of an information processing apparatus, has a control unit 101 that controls operation of the whole server, a hard disk drive 102 in which data such as management data is stored, and a network interface 103 that achieves communication through a local area network (LAN) cable or the like.

The control unit 101 has a central processing unit (CPU) 111, which is an example of a processor, a read only memory (ROM) 112 in which basic software, a basic input output system (BIOS), and the like are stored, and a random access memory (RAM) 113 used as a work area.

The CPU 111 may be a multi-core CPU. The ROM 112 may be a rewritable non-volatile semiconductor memory. The control unit 101 is a computer.

The hard disk drive 102 is a device that writes and reads data into and from a non-volatile storage medium having a disc-shaped substrate coated with a magnetic substance. Note, however, that the non-volatile storage medium may be a semiconductor memory or a magnetic tape.

In addition, the space management server 5 includes an input device such as a keyboard or a mouse and a display device such as a liquid crystal display device as needed.

The control unit 101, the hard disk drive 102, and the network interface 103 are connected through a bus 104 or a signal line (not illustrated).

A program executed by the CPU 111 may be offered to the space management server 5 while being stored in a computer-readable recording medium such as a magnetic recording medium (e.g., a magnetic tape, a magnetic disc), an optical recording medium (e.g., an optical disc), a magnetooptical recording medium, or a semiconductor memory. Alternatively, a program executed by the CPU 111 may be offered to the space management server 5 by using means of communication such as the Internet.

In the present exemplary embodiment, the term “processor” refers to a processor in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

Furthermore, the term “processor” is broad enough to encompass one processor or plural processors in collaboration which are located physically apart from each other but may work cooperatively. The order of operations of the processor is not limited to one described in the present exemplary embodiment, and may be changed.

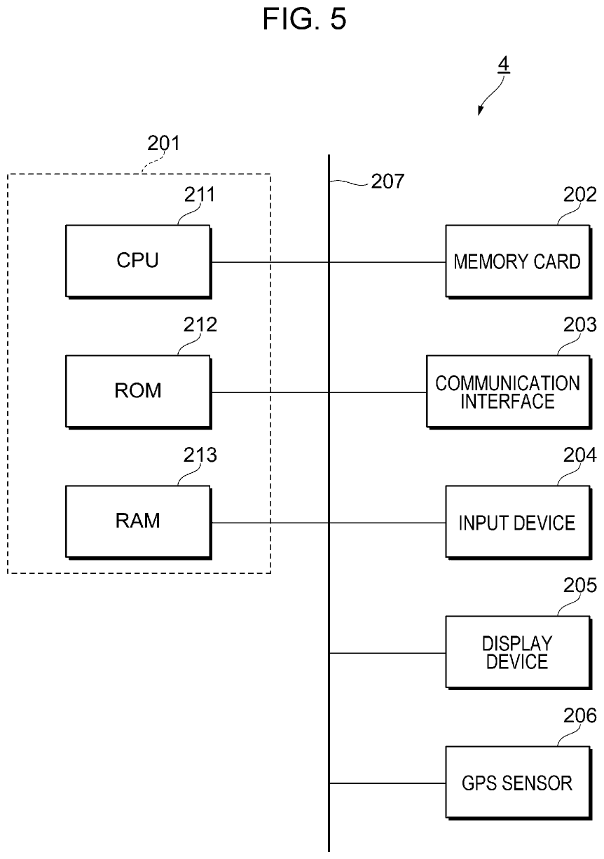

FIG. 5 is a diagram illustrating an example of a hardware configuration of the user terminal 4. FIG. 5 illustrates a case where the user terminal 4 is a smartphone.

The user terminal 4 has a control unit 201 that controls operation of the whole device, a memory card 202 in which various kinds of data are stored, various communication interfaces 203 that are compliant with a wireless communication standard, an input device 204 such as a touch sensor, a display device 205 such as a liquid crystal display device or an electro luminescence display device, and a global positioning system (GPS) sensor 206.

The control unit 201 has a CPU 211, a ROM 212 in which firmware, BIOS, and the like are stored, and a RAM 213 used as a work area. The CPU 211 may be a multi-core CPU. The ROM 212 may be a rewritable non-volatile semiconductor memory.

The communication interfaces 203 is, for example, an interface used for connection with a mobile communication system and an interface used for connection with a wireless LAN.

The GPS sensor 206 is a sensor that measures a position of the user terminal 4 on the basis of a radio wave received from a GPS satellite. Information on latitude, longitude, and altitude supplied from the GPS sensor 206 gives a current position of the user terminal 4. Note that the GPS sensor 206 may support an indoor position measurement system.

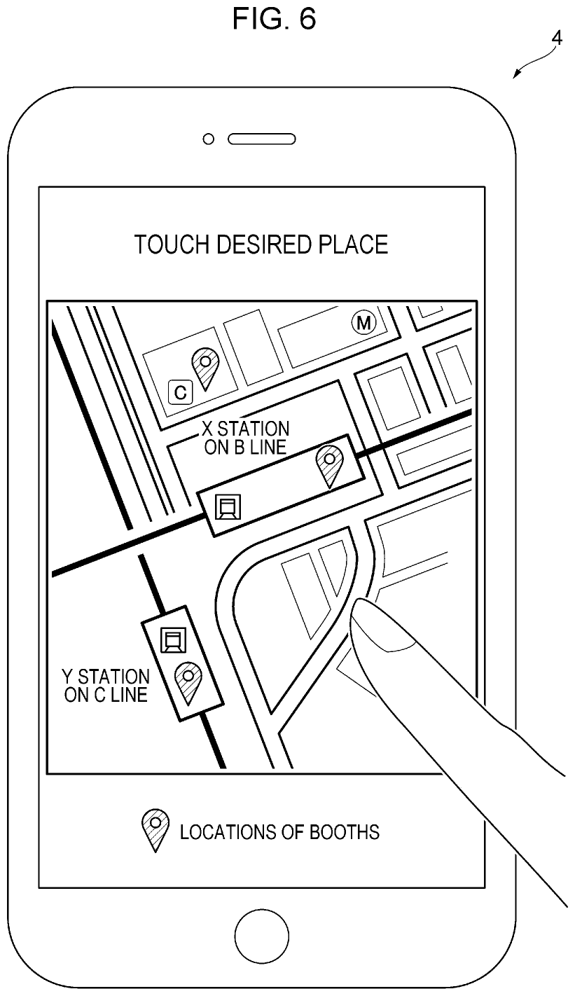

FIG. 6 illustrates an example of a display screen displayed on the user terminal 4 of a person who requests to reserve a space 2.

On the display screen illustrated in FIG. 6, a map is displayed, and plural locations of the spaces 2, which are examples of places which a person requests to reserve, are displayed on the map.

In the present exemplary embodiment, a person who wants to reserve a space 2 first selects a location from among the plural locations of the spaces 2 displayed on the map.

Note that the way in which the plural locations of the spaces 2 are displayed is not limited to this. For example, the plural locations of the spaces 2 may be displayed in a list form, and the person may select a location from the list.

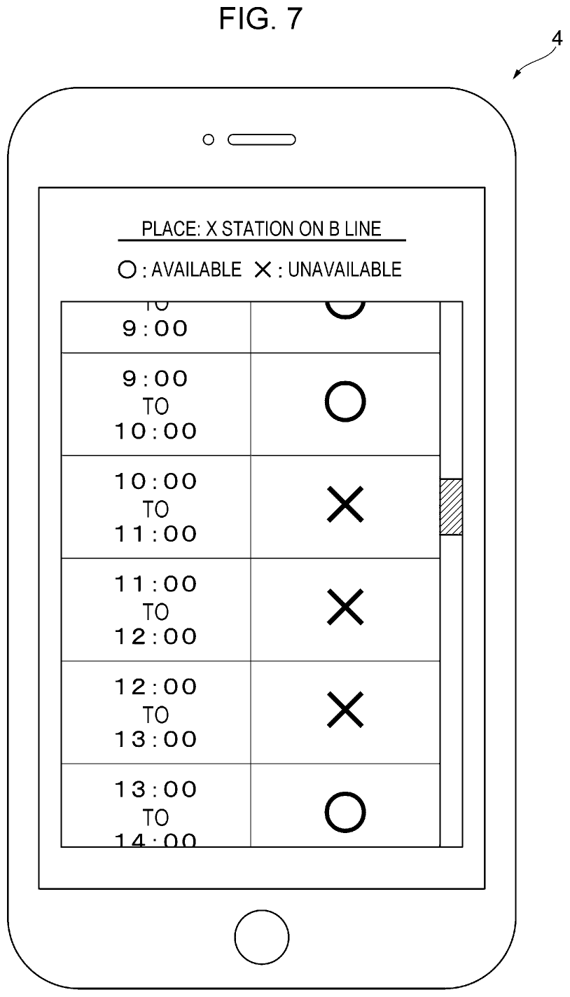

When the person selects a location, availability of the space 2 at the selected location is displayed as illustrated in FIG. 7, which illustrates another example of a display screen displayed on the user terminal 4. In FIG. 7, time windows for which the space 2 has already been reserved and time windows for which the space 2 is still available are distinguishable.

The person designates a time window for which the person wants to reserve the space 2 on the display screen. Then, the person presses “Reserve” button (not illustrated). The length, start time, and end time of the time window may be freely set by the person.

This causes the space management server 5 to reserve the space 2 for the time window.

More specifically, the space management server 5 receives information on the location of the space 2 and the time window and registers the information on the location of the space 2 and the time window in the hard disk drive 102.

Then, a confirmation of the reservation is sent to the user terminal 4, and thus the person is informed that the reservation has been confirmed.

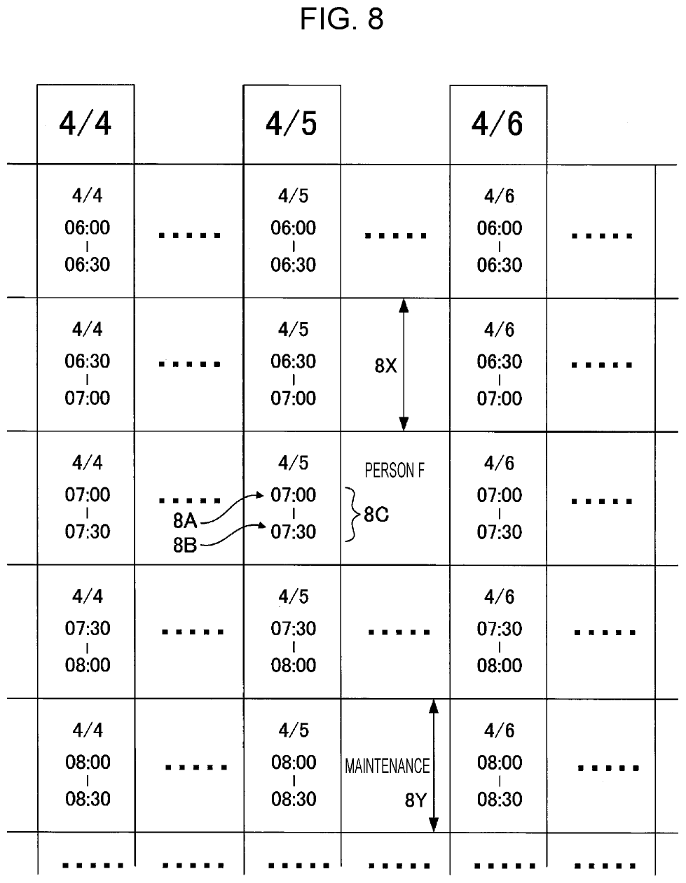

FIG. 8 illustrates a reservation list stored in the hard disk drive 102 (FIG. 4) of the space management server 5.

In the present exemplary embodiment, when a reservation of a space 2 made by a user is confirmed, the user is added as a reservation holder to the reservation list as illustrated in FIG. 8. More specifically, a reservation holder who made a reservation is registered in a field corresponding to a space 2 and a time window reserved by the reservation holder in the reservation list.

In particular, in the present exemplary embodiment, information (hereinafter referred to as “schedule information”) on schedule of the space 2 is registered in the hard disk drive 102 of the space management server 5.

In the example illustrated in FIG. 8, information indicating that a person F has reserved a time window 07:00 to 07:30 on April 5 is registered as schedule information.

Similarly, information indicating that a person has made a reservation is registered in other time windows although detailed description is omitted.

In the example illustrated in FIG. 8, information indicating that maintenance staff will do maintenance in a time window 08:00 to 08:30 on April 5 is registered as schedule information.

The maintenance done by the maintenance staff includes cleaning. For example, the maintenance staff does installation, replacement, and repair of equipment and cleaning of the space 2 during the time window for maintenance.

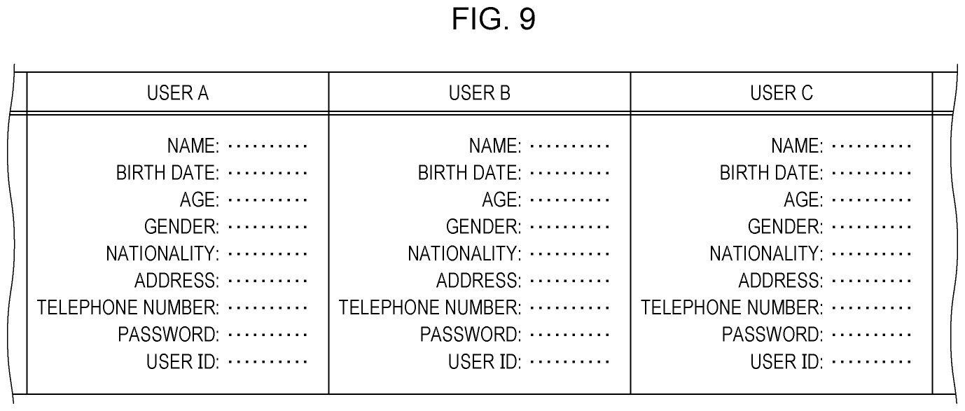

FIG. 9 illustrates a user list stored in the hard disk drive 102 of the space management server 5.

In the present exemplary embodiment, users of the spaces 2 need to complete user registration in advance. In the present exemplary embodiment, the users who try to register themselves as users enter information such as their names, birth dates, ages, genders, addresses, telephone numbers, and passwords, for example, on their user terminals 4.

In the present exemplary embodiment, these pieces of information are registered in the user list.

In the user list, information such as a name, a birth date, an age, a gender, an address, and a telephone number is registered in association with each user, as illustrated in FIG. 9.

In the user list, passwords set by the users and user IDs allocated to the users are also registered in association with the respective users.

In the present exemplary embodiment, upon receipt of an instruction to unlock a space 2 from a user terminal 4, the space management server 5 compares a user who gave the instruction to unlock the space 2 with users registered in the reservation list (see FIG. 8), and, if the user who gave the instruction to unlock the space 2 is registered in the reservation list, unlocks the space 2.

More specifically, in the present exemplary embodiment, when a reservation holder tries to unlock a space 2, the reservation holder enters an ID and a password on his or her user terminal 4. Through this authentication process, the operator who is operating the user terminal 4 is identified.

Then, in the present exemplary embodiment, when an instruction to unlock the space 2 is received from the user terminal 4 on which the operator has been authenticated, it is determined whether or not the operator who gave the instruction to unlock the space 2 is registered in the reservation list. In a case where the operator who gave the instruction to unlock the space 2 is registered in the reservation list, the space management server 5 unlocks the space 2.

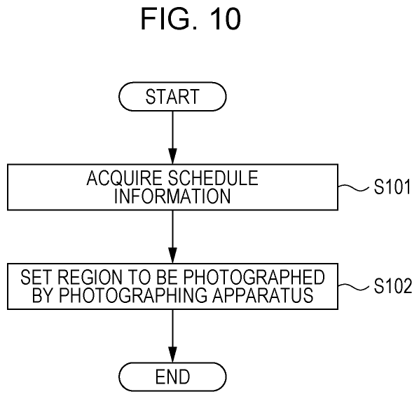

FIG. 10 is a flowchart illustrating an example of flow of processing executed by the CPU 111, which is an example of a processor, provided in the space management server 5.

More specifically, FIG. 10 is a flowchart illustrating flow of processing executed when the CPU 111 sets a region to be photographed by the photographing apparatus 24.

The CPU 111 according to the present exemplary embodiment reads out schedule information of a space 2 from the hard disk drive 102 every predetermined time interval (e.g., every 1 minute) (step S101).

Alternatively, the CPU 111 may read out schedule information of the space 2 from the hard disk drive 102 upon change of contents of the schedule information stored in the hard disk drive 102.

In the present exemplary embodiment, schedule information of the space 2 is registered in the hard disk drive 102 as illustrated in FIG. 8, and the CPU 111 reads out the schedule information from the hard disk drive 102.

Next, the CPU 111 according to the present exemplary embodiment sets a photographed region, which is a region to be photographed by the photographing apparatus 24, on the basis of the acquired schedule information (step S102).

In the present exemplary embodiment, the photographing apparatus 24 photographs the photographed region that has been set on the basis of the schedule information.

The photographing apparatus 24 mounted in the space 2 can photograph the space 2. However, an event can occur at various places in the space 2.

Therefore, it is not enough to simply mount the photographing apparatus 24. In a case where the photographing apparatus 24 is simply mounted, it may be impossible to photograph a target event and it may be impossible to know details of an event from a taken image.

Meanwhile, in the present exemplary embodiment, the photographed region is set on the basis of the schedule information. In this case, a region where an event is likely to occur is set as the photographed region. As a result, an event that occurs in the space 2 is photographed more accurately than a case where the photographing apparatus 24 is simply mounted.

Furthermore, in a case where the photographed region is set on the basis of the schedule information as in the present exemplary embodiment, the number of photographing apparatuses 24 mounted in the space 2 can be reduced.

Without the schedule information, it is hard to grasp where an event is likely to occur in the space 2. It is therefore necessary to mount a large number of photographing apparatuses 24 and thereby photograph a large number of regions in order to photograph an event completely and in detail.

Meanwhile, in a case where the photographed region is set on the basis of the schedule information as in the present exemplary embodiment, a region where an event is likely to occur is known beforehand. It is therefore possible to photograph an event that occurs in the space 2 by using a smaller number of photographing apparatuses 24.

Although a case where a single photographing apparatus 24 is mounted is described in the present exemplary embodiment, plural photographing apparatuses 24 may be mounted.

The photographed region setting processing in step S102 is described below.

The CPU 111 grasps, for example, a start of a time window of a reservation of the space 2 on the basis of the acquired schedule information and sets the photographed region, for example, so that an entrance of the space 2 is photographed at the start of the time window of the reservation of the space 2.

In particular, the CPU 111 sets the photographed region so that the photographing apparatus 24 faces the entrance of the space 2 at the start of the time window of the reservation of the space 2.

More specifically, in the present exemplary embodiment, the start of the time window of the reservation of the space 2 is, for example, “07:00” (see 8A in FIG. 8), and the CPU 111 sets the photographed region so that the entrance of the space 2 is photographed at 07:00.

More specifically, in the present exemplary embodiment, the entrance is a region where the door 22 (see FIG. 2) is provided, and the CPU 111 sets the photographed region so that the region where the door 22 (see FIG. 2) is provided is photographed at the start of the time window of the reservation of the space 2.

The CPU 111 controls a direction of the photographing apparatus 24 so that the photographing apparatus 24 faces the entrance (the door 22) at or before the start of the time window of the reservation of the space 2.

More specifically, the CPU 111 drives at least one of the moving mechanism, the first rotating mechanism, and the second rotating mechanism so that the photographing apparatus 24 faces the entrance (the door 22).

More specifically, in the present exemplary embodiment, correspondences between regions of the space 2 and control parameters for causing the photographing apparatus 24 to face these regions are registered in advance in the hard disk drive 102.

In a case where the CPU 11 causes the photographing apparatus 24 to face a region of the space 2, the CPU 111 reads out control parameters corresponding to this region from the hard disk drive 102 and drives the moving mechanism, the first rotating mechanism, and the second rotating mechanism by using the control parameters thus read out.

As a result, the photographing apparatus 24 faces this region.

Then, the CPU 111 according to the present exemplary embodiment analyzes an image obtained by photographing the entrance and thus identifies a person who enters the space 2 through the entrance. In particular, the CPU 111 analyzes an image obtained by the photographing apparatus 24 and thus identifies a person who enters the space 2 through the entrance.

More specifically, for example, the CPU 111 compares an image of a person obtained by analyzing the image with images of registered persons and thus identifies the person who enters the space 2 through the entrance. A known face recognition technique can be used to make this comparison.

In a case where the processing for identifying a person is performed, users of the space 2 are requested to register images of their faces in advance, and the images of the faces of the users are registered in the user list (see FIG. 9).

The CPU 111 identifies a person who enters the space 2 through the entrance by comparing an image of a face of a person obtained by analyzing the image obtained by the photographing apparatus 24 with the images of the faces of the users registered in the user list.

In the present exemplary embodiment, it is therefore possible to know whether a user who has an authority to use the space 2 has entered the space 2 or a person who has no authority to use the space 2 has entered the space 2.

In the present exemplary embodiment, a person who has entered the space 2 is identified by analyzing an image obtained by the photographing apparatus 24 that faces the entrance.

In such a case where a person who has entered the space 2 is identified on the basis of an image obtained by the photographing apparatus 24 that faces the entrance, this person can be identified more accurately.

Furthermore, in a case where the CPU 111 causes the photographing apparatus 24 to face the entrance as in the present exemplary embodiment, it is possible to improve accuracy of determination as to whether or not the number of persons who have entered the space 2 is larger than the number of persons for which the space 2 has been reserved.

In particular, in the present exemplary embodiment, the CPU 111 determines whether or not the number of persons who have entered the space 2 is larger than the number of persons for which the space 2 has been reserved by comparing the number of persons who have entered the space 2 through the entrance with the number of users of the space 2 (the number of users registered in the reservation list).

Accuracy of this determination can be improved in a case where persons who pass the entrance are photographed by using the photographing apparatus 24 that faces the entrance.

The CPU 111 may set the photographed region so that a specific region of the space 2 is photographed at an end of a time window of a reservation of the space 2.

More specifically, for example, the CPU 111 may set the photographed region so that a top of the desk 92 (see FIG. 3) and/or a region where user's baggage is placed (the box 93 for storing user's baggage) is photographed at an end of a time window of a reservation of the space 2.

More specifically, in the present exemplary embodiment, the end of the time window of the reservation of the space 2 is, for example, “07:30” (see 8B in FIG. 8), and the CPU 111 sets the photographed region so that the top of the desk 92 and/or the box 93 for storing user's baggage is photographed at 07:30.

In a case where the photographed region is set so that the top of the desk 92 and/or the box 93 for storing user's baggage is photographed, the CPU 111 moves and rotates the photographing apparatus 24 so that the photographing apparatus 24 faces the top of the desk 92 and/or the box 93 for storing user's baggage at or before the end of the time window of the reservation of the space 2.

In the present exemplary embodiment, it is therefore possible to more precisely grasp a status on the desk 92 and/or a status in the box 93 for storing user's baggage at the end of the time window of the reservation of the space 2.

A direction of the photographing apparatus 24 may be set so that both of the desk 92 and the box 93 for storing user's baggage are photographed at once.

Alternatively, only one of the desk 92 and the box 93 for storing user's baggage may be photographed. In this case, the photographing apparatus 24 is caused to face the one of the desk 92 and the box 93 for storing user's baggage.

Alternatively, for example, one of the desk 92 and the box 93 for storing user's baggage may be photographed earlier, and then the other one of the desk 92 and the box 93 for storing user's baggage may be photographed by changing the direction of the photographing apparatus 24 and moving the photographing apparatus 24.

The photographing apparatus 24 may take a moving image or may take a still image by photographing.

By thus photographing the top of the desk 92 and/or the box 93 for storing user's baggage, it is possible to detect a thing which a user has forgotten and left behind and/or detect a thing placed on the top of the desk 92 and in the box 93 for storing user's baggage.

To perform the detection, the CPU 111 may analyze an image obtained by the photographing apparatus 24 or an administrator of the space 2 may visually check the image.

In a case where the CPU 111 performs detection of a thing which a user has forgotten and left behind, the CPU 111 may notify, upon detection of a thing which the user has forgotten and left behind, the user terminal 4 of the user or a terminal operated by the administrator that the user has forgotten and left something behind.

The CPU 111 may perform detection of a suspicious object. Upon detection of a suspicious object, the CPU 111 may notify the terminal operated by the administrator about the presence of the suspicious object.

In this way, the user or the administrator is notified about the presence of a thing which the user has forgotten and left behind and the administrator is notified about the presence of a suspicious object.

The CPU 111 may determine whether or not a predetermined state has occurred in a specific region by analyzing an image acquired by the photographing apparatus 24 at an end of a time window of a reservation.

In a case where this processing is performed, first, the CPU 111 sets the photographed region so that a specific region is photographed at the end of the time window of the reservation.

Then, the CPU 111 determines whether or not a predetermined state has occurred in the specific region by analyzing an image of the specific region acquired by the photographing apparatus 24.

More specifically, for example, the CPU 111 determines whether or not there is something that has been broken in the specific region.

Alternatively, for example, the CPU 111 determines whether or not there is equipment that has disappeared in the specific region.

The specific region is, for example, the top of the desk 92. In this case, the CPU 111 determines whether or not there is a thing on the desk 92 that has been broken or determines whether or not there is equipment on the desk 92 that has disappeared.

Alternatively, the CPU 111 may set the photographed region so that the whole space 2 is photographed at the end of the time window of the reservation of the space 2.

In this case, the CPU 111 may determine whether or not there is a part of the space 2 that has been broken and/or whether or not a suspicious object has been placed in the space 2 by analyzing an image of the whole space 2.

To photograph the whole space 2, for example, the photographing apparatus 24 zooms out.

Alternatively, for example, the photographing apparatus 24 may move and rotate to photograph the whole space 2.

The CPU 111 may set the photographed region so that a specific region is photographed within the time window of the reservation of the space 2.

More specifically, for example, in the present exemplary embodiment, the time window of the reservation of the space is, for example, a time window 07:00 to 07:30 (see 8C in FIG. 8), and the CPU 111 may set the photographed region so that a specific region of the space 2 is photographed within the time window 07:00 to 07:30.

In particular, the CPU 111 may set the photographed region so that a specific region of the space 2 is photographed between the start of the time window of the reservation (see 8A) and the end of the time window of the reservation (see 8B).

Examples of the specific region include a region that is out of the field of view of the user, a region where an inflammable material is placed, a region where water leakage can occur, and a region where the window 42 (see FIG. 2) is provided.

The CPU 111 sets the photographed region so that at least one of these regions is photographed.

Within the time window of the reservation of the space 2, the user faces the monitor 32 (see FIG. 3). In this case, a region that is out of the field of view of the user is present behind the user.

More specifically, a region indicated by 3C in FIG. 3 is out of the field of view of the user.

In view of this, the CPU 111 according to the present exemplary embodiment sets, as the photographed region, this region behind the user. In this case, this region behind the user in the space 2 is photographed by the photographing apparatus 24.

In a case where the user of the space 2 is concentrating on work while facing the desk 92, someone may open the door 22 and steal a thing placed behind the user.

In the present exemplary embodiment, in a case where the region behind the user is set as the photographed region, a clearer image of a person who has stolen a thing behind the user can be obtained.

In a case where the photographed region is set so that the region where an inflammable material is placed is photographed as described above, a fire can be detected earlier even if this inflammable material ignites to cause a fire.

In the present exemplary embodiment, the region where an inflammable material is placed is, for example, a region where the box 93 for storing user's baggage is provided. in this case, the photographing apparatus 24 photographs the box 93 for storing user's baggage in detail.

In a case where the photographed region is set so that the region where water leakage can occur is photographed as described above, occurrence of water leakage can be detected earlier even if water leakage occurs.

In the present exemplary embodiment, the region where water leakage can occur is, for example, the air-conditioning apparatus 49 (see FIG. 2). In a case where the air-conditioning apparatus 49 has a cooling function, water leakage can occur in the air-conditioning apparatus 49.

In a case where the photographed region is set so that the air-conditioning apparatus 49 is photographed by the photographing apparatus 24, a detailed image of the air-conditioning apparatus 49 can be obtained. This improves accuracy of detection of water leakage in the air-conditioning apparatus 49. In particular, in a case where the CPU 111 performs detection of water leakage by analyzing an image obtained by the photographing apparatus 24, accuracy of detection of water leakage in the air-conditioning apparatus 49 can be improved.

In a case where the photographed region is set so that the region where the window 42 is provided is photographed as described above, for example, a person who looks into the space 2 through the window 42 can be photographed.

In particular, a suspicious person may possibly appear outside the window 42. In this case, in a case where the window 42 is photographed, a detailed image of this suspicious person can be obtained.

During a time window in which no user uses the space 2, the CPU 111 may set the photographed region so that the whole space 2 is photographed by the photographing apparatus 24.

More specifically, during a time window in which the space 2 has not been reserved by a user (e.g., a time window indicated by 8X in FIG. 8), the photographed region may be set so that the whole space 2 is photographed by the photographing apparatus 24.

During a time window in which no user uses the space 2, it is often impossible to narrow down a region where an event is likely to occur. In a case where the whole space 2 is photographed by the photographing apparatus 24, a problem that an event is not photographed at all is less likely to occur.

In particular, in a case where only a specific region of the space 2 is photographed, an event that occurs in a region other than this specific region cannot be photographed. Meanwhile, in a case where the whole space 2 is photographed by the photographing apparatus 24, an event that occurs in any region can be photographed.

The CPU 111 according to the present exemplary embodiment controls the photographing apparatus 24.

More specifically, as described above, the CPU 111 according to the present exemplary embodiment moves the photographing apparatus 24 and changes a direction of the photographing apparatus 24 so that a region set as a photographed region is photographed.

The CPU 111 also controls the photographing apparatus 24 itself.

Specifically, for example, in a case where lighting (the lighting apparatus 40 (see FIG. 3)) in the space 2 is off, the CPU 111 causes the photographing apparatus 24 to photograph the space 2 in a mode (photographing condition) different from that in a case where the lighting is on.

More specifically, for example, the CPU 111 causes the photographing apparatus 24 to photograph the space 2 in a night-vision mode. This makes it possible to obtain a clearer image of an inside of the space 2 even in a case where the lighting in the space 2 is off.

Alternatively, in a case where a predetermined output is received from a sensor provided in the space 2 during a time window in which no user uses the space 2, a region registered in association with this sensor may be set as a photographed region.

In particular, in a case where this processing is performed, regions in the space 2 are registered in advance in association with sensors provided in the space 2.

More specifically, correspondences between the sensors and the regions associated with the sensors are registered beforehand, for example, in the hard disk drive 102.

More specifically, in the present exemplary embodiment, the opening closing sensor S1 (see FIG. 2) for detecting opening and closing of the door 22 is provided. For example, the entrance of the space 2 is registered beforehand in association with the opening closing sensor S1.

In particular, a correspondence between the opening closing sensor S1 and the entrance of the space 2 is registered beforehand in the hard disk drive 102.

In this case, the CPU 111 sets the entrance of the space 2 as the photographed region in a case where an output is received from the opening closing sensor S1 during a time window in which no user uses the space 2 (during a time window in which there is no reservation of the space 2).

The CPU 111 moves and rotates the photographing apparatus 24 so that the photographing apparatus 24 faces this photographed region.

This makes it possible to obtain a more detailed image of a person who enters the space 2 during a time window in which no one is scheduled to enter the space 2.

In a case where the lighting of the space 2 is off although the photographing apparatus 24 is photographing the space 2, the CPU 111 may turn the lighting on.

More specifically, in a case where the lighting apparatus 40 (see FIG. 3) provided in the space 2 is off although the photographing apparatus 24 is photographing the space 2, the CPU 111 may turn the lighting apparatus 40 on.

In particular, in the present exemplary embodiment, in a case where the lighting apparatus 40 is off although the photographing apparatus 24 is photographing the space 2 under control of the CPU 111, the CPU 111 may turn the lighting apparatus 40 on.

This makes it possible to more clearly photograph an event that occurs in the space 2.

The CPU 111 may set the photographed region so that maintenance staff is photographed during a time window for maintenance of the space 2.

In particular, the CPU 111 may set the photographed region so that work down by maintenance staff is photographed during a time window for maintenance of the space 2.

More specifically, in the present exemplary embodiment, the time window for maintenance is a time window indicated by 8Y in FIG. 8, and the CPU 111 sets the photographed region so that the maintenance staff is photographed during this time window.

By thus photographing the maintenance staff, it is possible to grasp whether or not the maintenance of the space 2 satisfies a predetermined condition.

In a case where the photographed region is set so that maintenance staff is photographed, for example, the CPU 111 first analyzes an image obtained by the photographing apparatus 24 to detect a person included in the image.

In a case where no person is detected, the CPU 111 causes the photographing apparatus 24 to zoom out, rotate, and move so that a person is included in an image obtained by the photographing apparatus 24.

Then, in a case where a person is detected in an image obtained by the photographing apparatus 24, the CPU 111 thereafter rotates and moves the photographing apparatus 24 so that the photographing apparatus 24 faces this person.

More specifically, the CPU 111 rotates and moves the photographing apparatus 24 so that this person is located at a central part of an image obtained by the photographing apparatus 24.

As a result, in the present exemplary embodiment, the maintenance staff who does maintenance is photographed in detail.

The “maintenance staff” encompasses cleaning staff, and the “maintenance” encompasses cleaning.

In particular, the “maintenance done by maintenance staff” encompasses cleaning, and the maintenance staff does not only maintenance work such as installation, replacement, and repair of equipment, but also cleaning of the space 2 during a time window for maintenance.

In the present exemplary embodiment, not only the maintenance work such as installation, replacement, and repair of equipment, but also cleaning of the space 2 are photographed.

The CPU 111 may determine whether or not there is a thing which a user has forgotten and left behind in the space 2 by analyzing an image obtained by the photographing apparatus 24.

To determine whether or not there is a thing which a user has forgotten and left behind, the CPU 111, for example, compares an image obtained before the user enters the space 2 by the photographing apparatus 24 and an image obtained after the user leaves the space 2 by the photographing apparatus 24.

In a case where there is a thing which the user forgotten and left behind, the CPU 111 notifies the user terminal 4 of the user or the terminal apparatus (not illustrated) of the administrator that there is a thing which the user forgotten and left behind.

The CPU 111 may be configured not to determine that a thing placed by maintenance staff is a thing which has been forgotten and left behind.

More specifically, even in a case where the CPU 111 detects a thing that can be regarded as a thing that has been forgotten and left behind, for example, by comparing an image (an image obtained by the photographing apparatus 24) at a start of a time window for maintenance and an image at an end of the time window for maintenance, the CPU 111 does not detect this thing as a thing that has been forgotten and left behind.

In this case, it is less likely that equipment or the like newly placed by maintenance staff is regarded as a thing that has been forgotten and left behind.

The CPU 111 may further instruct the maintenance staff to photograph a specific region of the space 2.

More specifically, in this case, the CPU 111 transmits information indicative of the photographed region, for example, to the terminal apparatus of the maintenance staff.

In this case, for example, the maintenance staff photographs a designated region by detaching the photographing apparatus 24 mounted in the space 2 and using this photographing apparatus 24 or photographs the designated region by using a photographing apparatus (e.g., a camera) which the maintenance staff owns.

In this way, even a region that cannot be photographed by the photographing apparatus 24 and a region that is hard to be photographed by the photographing apparatus 24 can be photographed.

In the embodiment above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An information processing system comprising:
a processor configured to:
acquire schedule information on a schedule of a reservable place in which a photographing apparatus is mounted;
set a photographed region to be photographed by the photographing apparatus, and a photographing direction of the photographing apparatus, based on the acquired schedule information; and
set the photographed region and photographing direction so that an entrance of the reservable place is photographed at a start of a time window of a reservation of the reservable place.

2. The information processing system according to claim 1, wherein
the processor is configured to set the photographed region so that a whole of the reservable place is photographed by the photographing apparatus during a time window in which no user uses the reservable place.

3. The information processing system according to claim 1, wherein
the processor is configured to, in a case where lighting of the reservable place is off, cause the photographing apparatus to photograph the reservable place in a mode different from a mode in a case where the lighting is on.

4. The information processing system according to claim 1, wherein
the processor is configured to, in a case where a predetermined output is received from a sensor provided in the reservable place during a time window in which no user uses the reservable place, set a region registered in association with the sensor as the photographed region.

5. (canceled)

6. The information processing system according to claim 1, wherein
the processor is configured to analyze an image obtained by photographing the entrance and thus specify a person who enters the reservable place through the entrance.

7. The information processing system according to claim 1, wherein
the processor is configured to set the photographed region so that a specific region of the reservable place is photographed at an end of a time window of a reservation of the reservable place.

8. The information processing system according to claim 7, wherein
the processor is configured to set the photographed region so that a top of a desk placed in the reservable place and/or a region where baggage is placed in the reservable place is photographed.

9. The information processing system according to claim 7, wherein
the processor is configured to analyze an image obtained by photographing the specific region and thus determine whether or not a predetermined state has occurred in the specific region.

10. The information processing system according to claim 1, wherein the processor is configured to:
set the photographed region so that a whole of the reservable place is photographed at an end of a time window of a reservation of the reservable place; and
analyze an image obtained by photographing the whole of the reservable place to determine whether or not there is a part of the reservable place that has been broken and/or whether or not an object has been placed in the reservable place.

11. The information processing system according to claim 1, wherein
the processor is configured to set the photographed region so that a specific region of the reservable place is photographed within a time window of a reservation of the reservable place.

12. The information processing system according to claim 11, wherein
the processor is configured to set the photographed region so that at least one of a region that is out of a field of view of a user, a region where an inflammable material is placed, a region prone to water leakage, and a region where a window is located is photographed within the time window of the reservation.

13. The information processing system according to claim 1, wherein
the processor is configured to set the photographed region so that maintenance staff is photographed during a time window for maintenance of the reservable place.

14. The information processing system according to claim 13, wherein the processor is configured to:
analyze an image obtained by the photographing apparatus to determine whether or not there is a thing that has been forgotten and left behind in the reservable place; and
determine that a thing placed in the reservable place by the maintenance staff is not a thing that has been forgotten and left behind.

15. The information processing system according to claim 13, wherein
the processor instructs the maintenance staff to photograph a specific region of the reservable place.

16. The information processing system according to claim 1, wherein
the processor is configured to, in a case where lighting of the reservable place is off although the photographing apparatus is photographing the reservable place, turn the lighting on.

17. (canceled)

18. A non-transitory computer readable medium storing a program causing a computer to execute a process for information processing, the process comprising:
acquiring schedule information on schedule of a reservable place in which a photographing apparatus is mounted;
setting a photographed region to be photographed by the photographing apparatus, and a photographing direction of the photographing apparatus, based on the acquired schedule information; and
setting the photographed region and photographing direction so that an entrance of the reservable place is photographed at a start of a time window of a reservation of the reservable place.
